(19) United States
(12) Patent Application Publication
(10) Pub. No.: US 2008/0106154 A1
(43) Pub. Date: May 8, 2008

(54) ELECTROMAGNETIC ENERGY COLLECTOR

(76) Inventor: Joseph J. Boyd, Atlanta, GA (US)

Correspondence Address: TROUTMAN SANDERS LLP, 600 PEACHTREE STREET , NE, ATLANTA, GA, 30308, US

(21) Appl. No.: 11/557,465

(22) Filed: Nov. 7, 2006

(51) Int. Cl. H02J 17/00

(52) U.S. Cl. 307/149

(57) ABSTRACT

An improved reception of electromagnetic waves and transforming the energy the electromagnetic wave into electrical energy.

### BACKGROUND OF THE INVENTION

1. Field of the Invention

The present invention relates to the broad field of energy, and more specifically to improved reception of electromagnetic waves and transforming the energy the electromagnetic wave into electrical energy.

2. Description of the Related Art

At the present time there is no system developed to take electrical energy out of the electromagnetic waves on a large scale. This source of energy might be an answer to our needs. This energy is part of the field of alternative energy, and fits in with solar energy, water power, and wind power. Much work has been done recently to develop these sources of energy because we are rapidly depleting our main sources of crude oil. We still have gas, coal and nuclear energy to fall back on but each one has its own problems. The gas will need cross country pipelines for heating, or liquefying for overseas transportation. Coal can operate our electric utilities, but not our automobiles, and it spews out pollution. Nuclear energy is feared because of its great power, and the radioactive waste. Plenty of cheap electricity, available everywhere would be a Godsend.

There are two types of transformers that recover the electromagnetic energy. They are the half-length transformer and the full-length transformer, and each type has its own variations. This patent is for the half-length transformer which accumulates energy from an atmospheric electromagnetic wave. The term “half-length” means that only one-half of the collector coil collects the wave energy.

Along with this patent, another electromagnetic patent that take electrical energy from an electromagnetic wave is being processed. It's the full-length electromagnetic transformer, and it uses an oscillator to generates its own electromagnetic wave, which resonates with a full-length electromagnetic transformer, greatly increasing the gain. The full-length transformer is covered by a different patent.

### BRIEF SUMMARY OF THE INVENTION

The generation, sending and receiving of electromagnetic waves is as old as the field of radio itself, and we have developed the equipment to a high degree, but the collecting, storage and reuse of the energy of the wave is new and novel to this invention. Our electronic equipment transmits and receives electromagnetic energy at frequencies that extend from the longest radio waves to the very short ones. In addition to the energy that we broadcast, there are the natural sources of electromagnetic energy that arise from sun spots and flares, from the weather and from heat.

This patent is for a special type transformer unit made of a plain wire and one or more metallic shielded tubes that improve the reception and transmission of this energy, and when combined with a rectifier, that collects this electromagnetic energy. The unit is tuned to a desired frequency, using resistors, capacitors, and inductances. Since this collector unit may be made up primarily of a plain wire and a metallic shielded cable, it allows us to string the wires on existing poles, or in the walls of houses, and take the current right out of the air over a long distances. Or it may be composed of many turns of wire in a number of shorter shielded tubes, coupled with batteries, and made portable to act as an aerial or supply power for cell phones, lap tops, and other portable equipment.

And since the voltage collected is directly proportional to the length of the transformer windings, we can chose the length to get a desired voltage, or we can connect the units in parallel or series to increase the amperage or voltage. Since each unit is tuned to a particular frequency, each unit is complete and independent of the others.

Also the basic transformer of this invention acts as an aerial and it may be used as such. The receiving length of the equivalent aerial is the length of the winding, making possible a hundred foot aerial on a cell phone. The transformer acts as well as a transmitter as it does as a receiver.

When used as a television aerial, a number of coils of different lengths, connected in parallel, may be wound in a sheath, to increase the frequency range. The term wave will be used as the form of the high frequency electromagnetic energy even though the energy may be thought to be a pulse or a moving particle. Also the term electromagnetic will refer to the wave, even though the wave probably is electrostatic instead.

This invention uses two wires exposed to electromagnetic waves, to extract high frequency electrical currents. One wire is a plain wire and the other is an insolated wire enclosed in a metallic pipe like sheath that shields the wire from induction by the electromagnetic wave. This allows the shielded wire to conduct the induced charge in the plain wire. The basic nature of the electromagnetic wave induction process makes a shielded wire necessary.

A passing electromagnetic wave induces an electric charge in a wire. The charge is alternating, plus and minus, but is stationary. In order for the charge to move, we need another wire to complete a tuned circuit. However if we add another wire parallel to the first wire, the electromagnetic wave induces another stationary charge in this wire, exactly like the one in the first wire, and if we connect the ends of the wires, no current flows. We can complete the circuit and make the current flow in the first wire, if we shield the second wire by enclosing it in a metallic, pipe like sheath. The reason the shielded wire conducts the current of the first wire, is that no opposing charge is induced in the shielded wire by the passing electromagnetic wave. Unlike an ordinary electric current flowing in a wire, which induces a current in another wire, by building up and collapsing a magnetic field, an electromagnetic wave induces a static charge in a wire, and it does not build up and collapse a magnetic field to do it. The magnetic field of a current flowing in a wire will induce a current into a wire shielded by a metallic sheath, but an electromagnetic wave will not induce a charge in the same wire enclosed in the metallic sheath.

The “coaxial cable” is a means of blocking the induction by the electromagnetic wave, but it also keeps down static and induced magnetic interferences. The coaxial cable has a single inner concentric wire surrounded by a metallic sheath. One end of the concentric wire is normally connected to the aerial and the other end is connected to the receiver or transmitter. The outer shield is grounded.

The present patent not only doesn't have a sheath with a single concentric wire to block the magnetic induction, it has as many wires as we need within the sheath, and uses only the principle that the metallic sheath blocks the electromagnetic wave, and prevents it from inducing a charge on the inside wire. Also, this patent has unshielded wires outside of the sheath to accept the induced charges of the electromagnetic wave, and uses the shielded wire to close the circuit. This patent covers the coaxial cable when combined with an outside wire and used in this manner.

The induction of a current in a wire by an electrical current in another wire, and the induction of a charge by a passing electromagnetic wave, are two distinct and different ways to induce a current in a wire and this patent makes use of the electrostatic method.

These and other objects, features and advantages of the present invention will become more apparent upon reading the following specification in conjunction with the accompanying drawing figure.

### BRIEF DESCRIPTION OF THE FIGURES

FIG. 1 is a view of an electromagnetic wave passing two side by side wires that are tuned to resonate at the wave frequency. The wave generates equal alternating charges in each wire, and no current flows when the wires are connected.

FIG. 2 is a view of two tuned wires, where the outer metal sheath of one prevents the passing electromagnetic wave from inducing a charge in the shielded inside wire. The charge in the outside wire can now flow freely through the sheathed wire.

FIG. 3 is a view of a the shielded wire, beside the plain wire where the ends of the wires are connected together at the bottom, and a tuned circuit resonates with the wave, and a rectifier unit converts the alternating current to DC current.

FIG. 4 shows a number of bare wires and concentric wire cables in parallel, with the wires and cables connected in series, coupled to a tuned resonator circuit and a rectifier unit.

FIG. 5 is the circuit of the half-length electromagnetic transformer, tuned to resonate at a desired frequency, with a half-wave rectifier circuit to change the alternating current to direct current.

FIG. 6 is a view of FIG. 5 where the high frequency coil is center tapped to make possible a full-wave rectifier unit.

FIG. 7 shows a view of the sinusoidal current 50 flowing in the circuit due to resonance. It was one of the many electromagnetic waves 51 before the circuit was tuned to resonate at that frequency.

FIG. 8 is a view where a number of the half-length transformer units or concentric wire units, are hung on poles.

FIG. 9 is a small radio circuit, where the half-length transformer replaces the aerial and tuner.

FIG. 10 is a view where a number of inductor units are combined in series to increase the voltage.

FIG. 11 is a view where a number of inductor units are combined in parallel to increase the amperage.

### DETAILED DESCRIPTION OF THE PREFERRED EMBODIMENTS

The basic principle making possible the collection of the resonating electromagnetic energy is made clear with FIG. 1, where the passing electromagnetic wave 6 generates an alternating electric charge in the wire 10. To close the circuit so that the induced charge can circulate, we have added a second wire 11, but the electromagnetic wave 6 induces a charge in the second wire exactly like the one in the first wire, and if we connect the ends of the wires together, no current will flow. Any effort to circulate the charge induced in wire 10 is blocked by an equal opposing charge in 11.

In FIG. 2 we have replaced the wire 11 with wire 13, which is shielded by sheath 14 which blocks the wave and prevents the induced static charge. When an electromagnetic wave 7 passes the wires 11 and 13, the wave is stopped at the sheath 14 and does not induce any charges in the concentric wire 13. This allows the inside wire 13 to conduct the charge induced in the wire 12.

In FIG. 3 we see a bare wire 22 connected by another wire 24 to a wire 21 inside the sheathe 20. The electromagnetic wave induces a charge in wire 22, which, is caused to resonate in the tuned series circuit of resister 23, coil 28, and capacitor 25. The high frequency alternating current is converted to DC current by the rectifier 23, collected by the capacitor 26 and drives the load 27. The rectifier is necessary on each collector unit, because we can add the direct currents of the separate units, but the alternating currents of the units might be out of phase and cancel out.

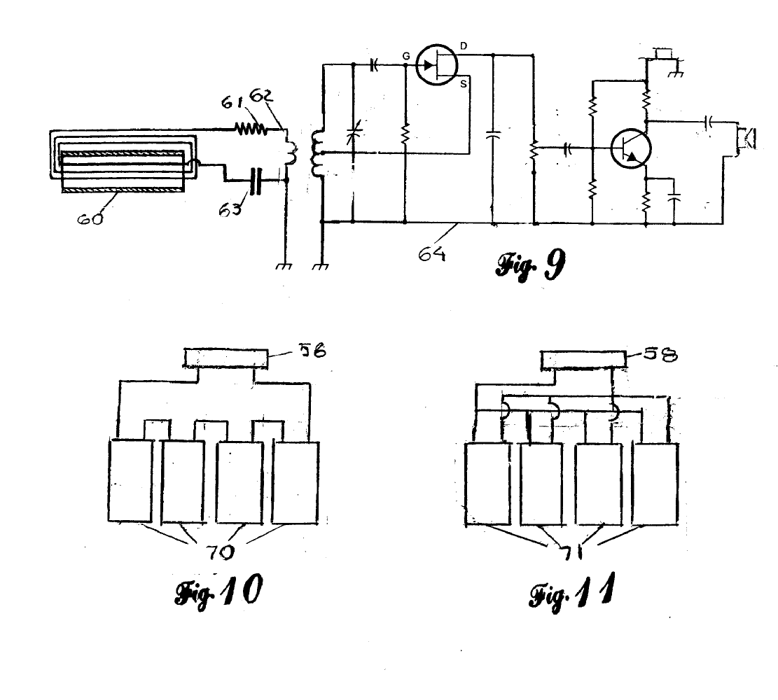

FIG. 4 shows a number of bare wires and concentric wire cables in parallel, with the wires and cables connected in series, coupled to a tuned resonator circuit and a rectifier unit. These units may be strung on poles like telephone lines FIG. 8, or in the attics of houses. In this case three wire and cable units are in series. The outer sheath 30 of the cable with its inner wire 32 connected to the outside wire 33 is seen. The wires 32 and 31 of the three units are connected to the tuned circuit of resister 38, coil 34, and capacitor 39. The rectifier 35 converts the current to DC current which is collected by the capacitor 36 and supplies the load 37.

In FIG. 5 we have a half-length transformer unit 40, tuned to resonate at a particular frequency. It has a metallic pipe like sheath 40, having a wire threaded up through the inner opening and down on the outside, a number of times to form a continuous inside winding 48, and an outside winding 49, and the ends of the winding are connected to a resistor 41, a variable capacitor 42 and an impedance 43 to tune the circuit. To help tune the circuit, the sheath may be extended to a quarter or half of the wave length. The rectifier circuit 44 is used as before to convert the alternating current to DC current. A full wave rectifier circuit is shown in FIG. 6. The coil 56 is center tapped at 55 with the two rectifiers 53 and 54, and the load 57.

To increase the amount of accumulated energy we can add many turns of wire to the transformer. Here the outside wires and inside wires, in series, are threaded through the metal sheath, and since each of the outside wires are of the same length, and since they are parallel and close together, a passing electromagnetic wave induces equal charges in each of the outside wires. These induced charges are exactly in phase and connected in series, so that the voltages add up to an amount proportional to the number of outside wires.

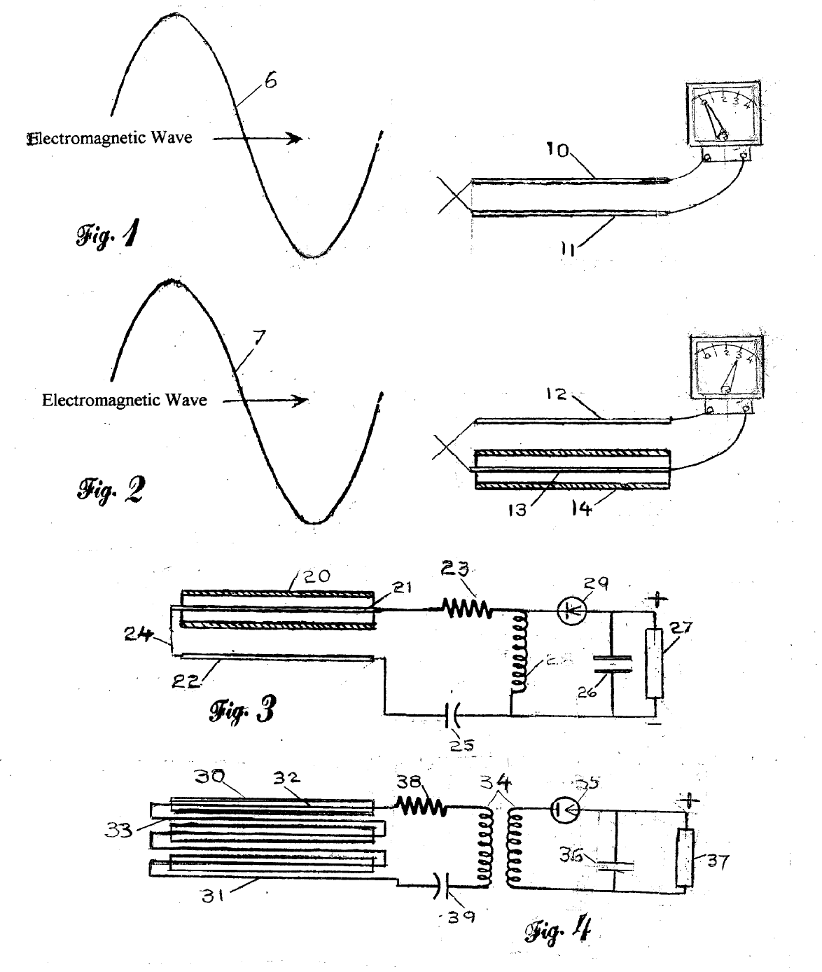

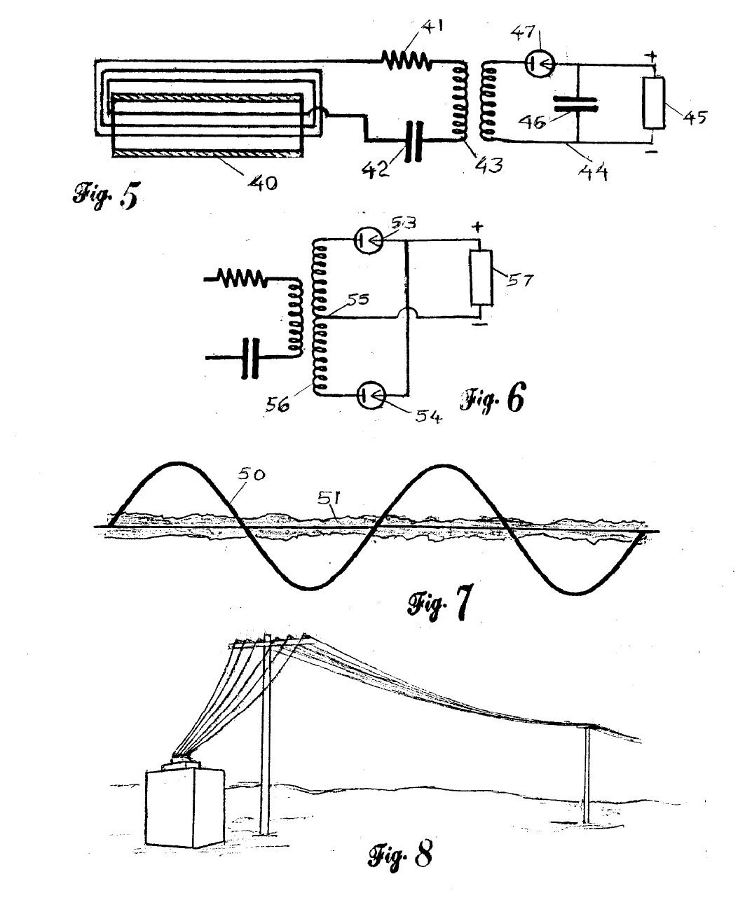

When we bring the system to resonance, it greatly amplifies the induced charges and causes the current to flow from the outside wire through the shielded inside wire. The sinusoidal curve 50 of a frequency tuned to resonance is shown in FIG. 7. Resonance causes the curve to be greatly magnified above the background waves 51. Before tuning, the curve 50 was one of the many electromagnetic waves 51.

Since the transformer units are basically wires and tubes, they are easily strung on poles along with power lines and phone lines. FIG. 8 shows this type setup. Also they can be hung on the walls of houses or in the attics of houses. They work equally well when hung vertically from towers.

FIG. 9 is a radio circuit, where the half-length transformer 60 replaces the aerial. The system is tuned to the desired frequency with the resistance 61, capacity 63 and the inductance 62. The simple radio circuit 64 has a detector and amplifier. This would greatly increase the sensitivity of the cell phones and lap top computers. In addition to reducing the size of the aerials, these collector units, minus the rectifier may be used to bring in signals that are too weak for ordinary reception.

As a general rule the same laws apply the all aerials, whether they are receivers or transmitters, and the same aerials can be used for both reception and transmission.

FIG. 10 is a view where a number of inductor units are combined in series to increase the voltage.

FIG. 11 is a view where a number of inductor units are combined in parallel to increase the amperage.

There may be more than one set of collector wires, and the wires may be of different sizes and of different turns. The current may be changed to sixty cycle current with a vibrator or the DC current can drive a dynamotor to supply a normal AC power supply.

These units may be reduced in size to power cell phones or made into plug-in power supplies for cell phones or lap top computers. These power supplies could be composed of one or more collector units and a battery, and made to plug into the electronic equipment. They would be charging at all times.

Larger collector units may be used to power ships and all types of vehicles.

The electromagnetic waves also induce electrical charges in the sheaths, but since they are insolated from each other, there is no return circuit for the sheath, and no current flows.

While the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. An electromagnetic energy transformer unit that collects induced electric currents from electromagnetic waves, comprising one or more metallic, pipe like sheaths, wherein an insolated wire is threaded up through the inside opening of the sheaths and down on the outside, one or more times, making a series coil, wound on each sheath, partly inside of the sheath and partly on the outside of the sheath, so that a passing electromagnetic wave induces an electrical charge in that part of the winding that is outside of the sheath, but is blocked by the sheath from inducing a charge on the inside part of the winding, and this allows the inside winding to conduct the alternating charge from the outside winding as an electrical current, and this current may be used elsewhere in an electronic circuit, or altered and used as a power source.

2. The electromagnetic energy transformer unit of claim 1, where the inside and outside coil is combined with variable capacitors, resistors, and impedances to tune the unit to resonate with a particular electromagnetic wave to increase gain.

3. The electromagnetic energy transformer unit of claim 1, where the inside and outside coil is combined with a rectifier circuit, to rectify the collected alternating electrical currents, and the DC current produced is stored in capacitors.

4. The electromagnetic energy transformer unit of claim 1, where two or more sheaths with their inside and outside coils are combined with rectifier circuits, to produce full-wave rectification of the collected alternating electrical currents, and the DC current produced is stored in capacitors.

5. The electromagnetic energy transformer unit of claim 1, where a number of the units are connected in parallel to increase the current.

6. The electromagnetic energy transformer unit of claim 1, where a number of the units are connected in series to increase the voltage.

7. The electromagnetic energy transformer unit of claim 1, where the lengths of the units are some multiple of the wave length of a particular electromagnetic frequency.

8. The electromagnetic energy transformer unit of claim 1, where the units are reduced in size to charge batteries and to power cell phones and other small portable equipment.

9. The electromagnetic energy transformer unit of claim 1, where the sheaths and the inside and outside coils are put into walls and attics of houses to supply power for operating household appliances.

10. The electromagnetic energy transformer unit of claim 1, where the sheaths and the inside and outside coils are long and may be strung on poles along with power lines to pick up energy over a wide area.

11. The electromagnetic energy transformer unit of claim 1, where the units are hung from towers.

12. The electromagnetic energy transformer unit of claim 1, where the units are used to power ships and vehicles.

13. The electromagnetic energy transformer unit of claim 1, where the unit is tuned to a particular frequency, and replaces the aerial, or tuning coil of a receiver to improve reception or transmission in television, radio, computers, cell phones and other electronic equipment.
